(19) United States
(12) Patent Application Publication
(10) Pub. No.: US 2015/0317738 A1
(43) Pub. Date: Nov. 5, 2015

(54) COMPUTERIZED METHOD AND SYSTEM FOR SECURE COMMUNICATION, AND METHOD AND SYSTEM FOR MATCHING CUSTOMERS WITH OPTIONS FOR INVESTMENT

(71) Applicant: Sunil Kishore DALAL, Mumbai (IN)

(72) Inventors: Sunil Kishore DALAL, Mumbai (IN); Apurva SHARAN, Bangalore (IN)

(21) Appl. No.: 14/651,038

(22) PCT Filed: Dec. 10, 2012
(86) PCT No.: PCT/SG2012/000464

§ 371 Date: Jun. 10, 2015

(51) Int. Cl. G06Q 40/06; H04L 29/06; H04L 12/26

(52) U.S. Cl. CPC G06Q 40/06; H04L 43/10; H04L 65/1069

(57) ABSTRACT

A computerized system includes a server which can be accessed by a plurality of customers (investors), and by suppliers of options for investments. The suppliers upload the options to the server. Each investor creates an investment profile indicative of investments suitable for that investor, and the server automatically matches the investors to one or more of the options for investment according to the profile, and transacts chosen investments based on data entered using said functions. Customer-specific data describing the details of the investments made by the investors is stored at locations associated with the investors, and a computer system at that location repeatedly forms a temporary communication path with the server, so that, in the case that a report is to be produced based on the data, the server can communicate with the computer system at the location associated with the customer to obtain the required data.

### FIELD OF THE INVENTION

The present invention relates to a computerized method and system for secure communication between users and a server. It further relates to methods and systems for matching customers with options, particularly options for investments. The secure communication may be used to provide secure reporting of investment performance.

### BACKGROUND OF THE INVENTION

The last few years have seen an unprecedented expansion of wealth which has resulted in a phenomenal growth in the number of high net worth individuals (HNIs) who wish to invest their wealth. These investors rely on financial advisors to suggest investments to them. Financial advisors attempt to suggest optimum asset allocation, balancing risk versus return, by adjusting the percentage of each asset class in an investment portfolio according to the investors' risk tolerance, financial goals and investment time frame.

This is far from being a straightforward task, in view of the very large number of options for investment now available: not only traditional options for investment such as equity, mutual funds, government securities, corporate bonds, etc, but also real estate, and collectables such as works of art, wine, etc. The assessment of the risk associated with these options is somewhat subjective. If certain classes of assets have a strongly correlated performance then risk will not be reduced by diversifying investments between them, but predicting the correlation between the performances of asset classes is also subjective. The investor has to take it on trust that the financial advisor is performing this role in a reasonable way.

Under their professional obligations, regulated financial advisors present investors with a risk questionnaire which details their investment objectives, such as the degree of risk which the investor is prepared to accept, so that the financial advisor can suggest appropriate investment portfolios.

Unfortunately, the questionnaires are normally filed away after their completion. Usually within a few months of the start of a new relationship and/or on departure of the advisor from the firm he works for, little attention is paid to the risk profile and its outcome. Furthermore, in a situation where the client has multiple advisor relationships (which is typically the case with HNIs), the consolidation of the various risk profiles and outcomes is usually never recorded or optimized.

The investor further has to take it on trust that the investments selected made by the financial advisor are not chosen on the basis of ulterior motives, such as a commission which the financial advisor may receive for suggesting a certain product. Unregulated service providers not governed by compliances, pitch any deal that they have to sell regardless of the risk profile of investor often resorting to mis-selling. In such cases, investors are flooded with sales enquiries and would necessarily need to go through each deal and participate in discussions to decide if the particular deal matches their risk return criteria. Often, investors do not have the time or competence to make such judgments.

A further type of risk which the investor suffers is that there may be a security failure at the database of the financial advisor. On the one hand it is desirable that the financial advisor's database should be internet enabled, so that the investor can obtain from it information about the performance of his investments. On the other hand, this connection to the internet means that the database presents an attractive target to corrupt individuals.

Typically a HNI has multiple financial advisors, and must obtain information from each of them separately. Then, this information has to be made available to other professionals, such as accountants for preparation of tax returns. This is a complex and time consuming process. Mistakes, or security lapses in transferring data, may have serious consequences.

### SUMMARY OF THE INVENTION

The present invention aims to provide methods and systems for automated handling of investments.

The methods and systems may be used by “customers” (investors) and by suppliers of options for investment. The term “suppliers of options for investment” means individuals or organisations which each wish to sell one or more investments. It is used to include “merchants” which are in the business of selling options (such as hedge funds, estate agents, investment advisors etc). It may further include investors who wish to sell one or more investments. This may be an investment previously purchased using the system, though it may also be an investment not bought using the system.

In a first aspect, the invention proposes in general terms a computerized system having a internet-enabled server which can be accessed by a plurality of customers, and by suppliers of options for investment. The suppliers of options for investment upload the options to the server. Each customer creates an investment profile indicative of investments suitable for the customer, and the system automatically matches the customers to one or more of the options for investment according to the profile.

The profile may be a risk profile. Thus, in contrast to known systems, the customer is assured of the investments suggested being in line with the profile. Furthermore, the compliance of the customer's investment portfolio with the profile may be checked at intervals by comparing them to identify discrepancies, so that the investment portfolio can be rectified.

Additionally or alternatively, the profile may include data describing customer-defined preferences, such as data characterising the investments a customer wishes to consider making. These may, for example, include any one or more of types of investment (e.g. real estate, bonds, stocks, commodities etc), geographical locations related to investment (e.g. real estate locations), acceptable ranges of the amounts of the investment, etc).

A second aspect of the invention proposes in general terms that data concerning investment portfolio of a customer is held in a computer system associated with the customer, such as at a location controlled by the customer. The customer's computer system periodically makes contact with a server in the public domain (that is, having a constant and publicly-known internet address), to establish a temporary communication path. Upon a request being received by the public-domain server to produce a report relating to the customer, the public-domain server obtains the required data from the computer system associated with the customer according to the temporary communication path, and passes it on without retaining a copy of it.

Thus, the customer is able to access the data from any computer which can make contact with the public-domain server, yet the customer's data does not have to be permanently present on the public-domain server. Thus, the security risk if the public-domain server is compromised is reduced. Instead, the computer system associated with the customer may be a secure intranet network associated with the customer.

The process flow is as follows:

a. Each intranet has a unique identifier associated with it. This identifier is maintained on the public-domain server.

b. The public-domain server stores a mapping between each intranet identifier and a customer. This customer has permission to access data, either using the intranet or the public domain server.

c. The public-domain server provides a web service API (application programming interface) through which intranet servers can check for the logon status of their respective customers.

d. A customer may use a browser to visit a URL corresponding to the public-domain server, but the page corresponding to the URL can be only generated with data that resides on the corresponding intranet server. Note that this page is generated by a function (let us call it an ‘action’) that executes on the intranet server.

e. The action corresponding to the URL stores the request for data in a queue that is managed on the public-domain server. This queue is managed in a database table. The action also opens a message queue (MSGQ) and starts waiting for response to become available on the MSGQ. This act of waiting on the MSGQ for data puts the action in a blocked state.

f. Intranet servers periodically connect with the public-domain server to check if any of its customers are currently logged in. If a customer is logged in, the public server responds with this information.

g. When the intranet server finds out that a customer is logged into the public-domain server, it creates a new HTTP connection with the public server. The intranet server, through this new connection, checks to see the type of data asked for. The public server checks its queue and responds back to the intranet server.

h. Intranet server assembles the required data and sends it to the public domain server on the previously opened connection.

i. The public-domain server stores this data in the previously created MSGQ. Since MSGQ is a construct provided by the operating system and it stores its data in memory associated with the web server process, the data is secure and no other process can access this data.

j. The act of putting data on the MSGQ unblocks the previously blocked action (see point ‘e’ above). The action resumes execution, pulls the required data, generates the required page and sends it to the registered customer.

Preferably the public-domain server does not store the data sent by the intranet server in any permanent storage, such as on the public-domain server, so no explicit deletion step is required. The data cannot be retrieved at any point during or after the process above is completed.

The system has the two sorts of user mentioned above:
the customers
the suppliers of options (who, as mentioned, may be merchants, or who may be customers in respect of some transactions)

Additionally, there are two other sorts of user:
“Back Office Operator”—these people are employed by the customer and operate only a dedicated computer in the location associated with the customer.
“Administrators”—these people associated with the owner of the server, and whose task may include approving content posted on the server by suppliers of options (i.e. check the suitability of the options) and/or approving content posted by customers.

### BRIEF DESCRIPTION OF THE EMBODIMENTS

An embodiment of the invention will now be described with reference to the following figures, in which:

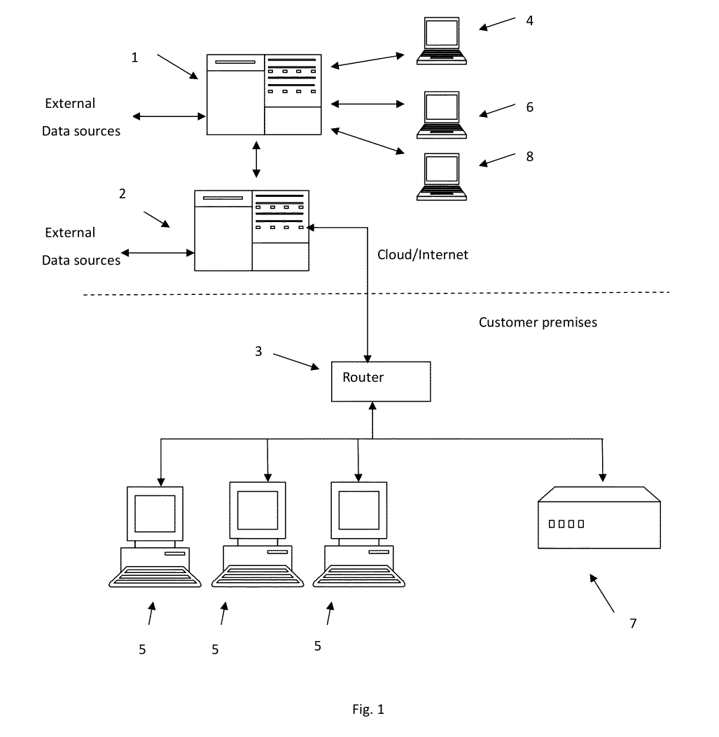

FIG. 1 is a schematic diagram of a system which is an embodiment of the invention;

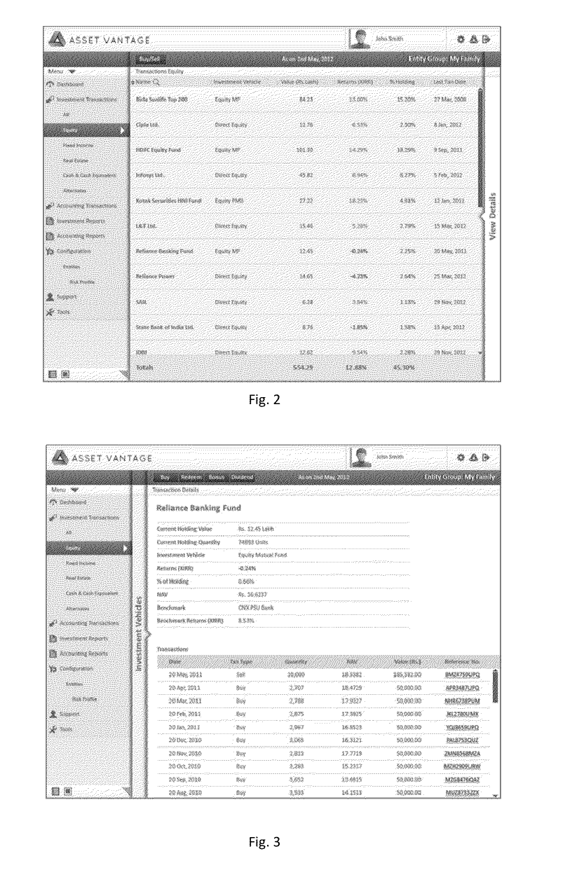

FIG. 2 shows an interface presented to a customer by the system of FIG. 1;

FIG. 3 shows another interface presented to the customer by the system of FIG. 1;

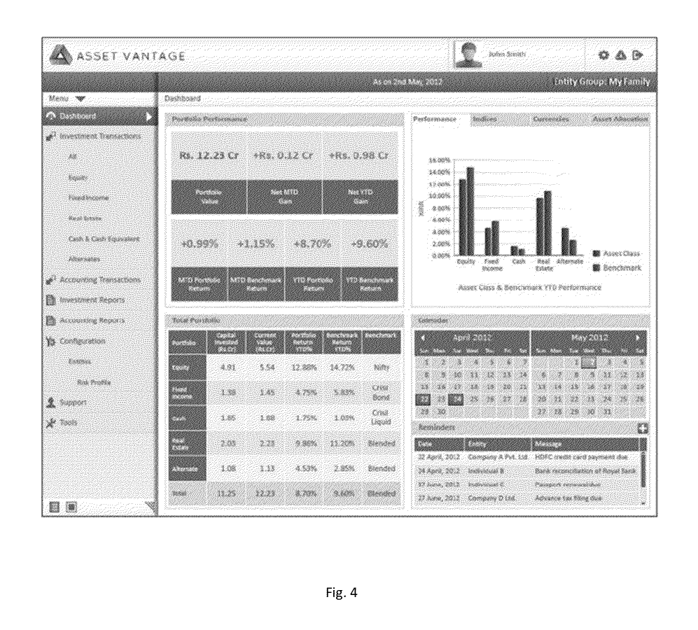

FIG. 4 shows another interface presented to the customer by the system of FIG. 1; and

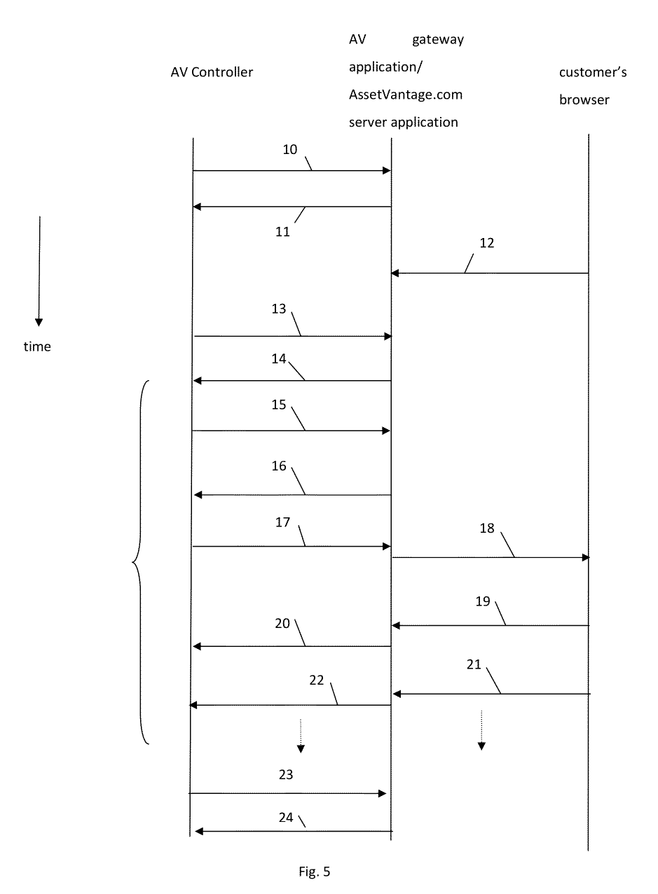

FIG. 5 shows the timeline of a process used by the embodiment of FIG. 1 to produce a report.

### DETAILED DESCRIPTION OF AN EMBODIMENT

Referring firstly to FIG. 1, an embodiment of the invention is shown. This embodiment is named the “AssetVantage system”.

A first component of the embodiment is a pair of co-operating software applications. In FIG. 1, the applications are illustrated as running on different respective servers 1, 2, which are both connected to the internet, and which are connected to each other by a secure data channel. However, in other embodiments the two software applications run on the same physical hardware, i.e. they may be different software applications running on a single server.

A first of the software applications, the one depicted in FIG. 1 as running on server 1, is associated with a domain name, which may for example be AssetVantage.com, so the application is referred to below as the AssetVantage.com server application 1. The AssetVantage.com server application 1 is for communication with users of the system, who operate browser software on respective internet-connected terminals, and connect to the AssetVantage.com server application 1 over the internet. FIG. 1 illustrates three such terminals 4, 6, 8, though there may be any number of such terminals. The AssetVantage.com server application 1 thus presents a “public face” of the embodiment. The terminals 4, 6, 8 may be of any type, e.g. laptop, tablet, PC, phone etc.

The users of the system include suppliers of options for sale (in some cases one or more of the customers may themselves act as suppliers of options). When such a supplier of options connects to the AssetVantage.com server application 1 (e.g. using the terminal 4), the AssetVantage.com server application 1 presents an interface called a “business partner view” which allows the supplier of options to propose an option to be offered to sale.

The users of the system further include one or more individual registered customers who can perform several actions, including purchasing items offered by the suppliers of options. Each customer is thus an investor. Each of the customers is associated with respective location (“customer premises”) as described in detail below, but they may also wish to connect to the AssetVantage.com server application 1 using a terminal (e.g. the terminal 6), for instance to obtain reports concerning their investments. If they connect to the AssetVantage.com server application 1 using the terminal 6, the AssetVantage.com server application 1 presents an interface called a “customer view”. Another of the actions a customer might want to carry out is to post content on the AssetVantage.com server application 1 for viewing by other users.

The users of the system further include administrators associated with (e.g. employed by) the owner of the servers 1, 2. When an administrator connects to the AssetVantage.com server application 1 (e.g. using the terminal 8), the AssetVantage.com server application 1 presents an interface referred to as a “AV administrator view” which allows the administrator to approve content posted on the server by suppliers of options (i.e. check the suitability of the options) and/or approve content posted by customers.

The AssetVantage.com server application 1 is further able to obtain data from additional data sources (shown at the left of FIG. 1), such as sources which provide market pricing data and/or benchmark data.

The second software application, the one depicted running on server 2, is below called the AV gateway application 2. As noted above, the one or more individual registered customers of the AssetVantage system are each associated with a corresponding location (e.g. their home or their office). FIG. 1 shows the location for one such customer, labeled their “customer premises”. The customer premises include a router 3 for communicating with the internet via a second WAN link, as well as one or more computers 5 and a customer-side server 7 (referred to here as the AV CONTROLLER). The router 3 communicates with computers 5 and the AV CONTROLLER server 7 via a LAN network (intranet). The AV CONTROLLER server 7 includes a firewall at its input from the LAN network. Optionally, the AV controller may be able to communicate, via the router 6, also with external data sources, for example to obtain market pricing or benchmarking data.

The router 3 communicates with the AV gateway application 2 over the internet, and the AV gateway application 2 provides a bridge between the AV CONTROLLER server 7 and the AssetVantage.com server application 1. In other words, the AV gateway application 2 acts as an interface of the AssetVantage.com server application 1, for use by the AV CONTROLLER 7. The communications between the router 3 and the AV gateway application 2 may be made secure, e.g. by encrypting them.

Additional functions which may be provided by the AV gateway application 2 include allowing an AV administrator to perform customer usage pattern monitoring, such as any of
a. the customer's risk profile
b. the asset allocation
c. feature usage monitoring
d. exception handling for notification & events

The AV gateway application 2 may also perform update notification & distribution. The AV CONTROLLER server 7 is the second main component of the embodiment. In reality there will be multiple AV CONTROLLER servers 7, one for each of the respective customers (investors) of the system. Each AV CONTROLLER server 7 is associated with a respective identifier (“AV CONTROLLER license key”) which can be recognised by the AV gateway application 2.

An AV CONTROLLER server 7 may be provided for example in the form of a dedicated hardware device. This may be provided as a small form factor PC, such as a Lenovo M72e desktop. It comprises all the software functionality to communicate with the AssetVantage.com server application 1 via the AV gateway 2, and to generate customer interfaces which the customer can access using the computers 5. It also stores data describing the investments which have been made using the AssetVantage.com server application 1 and the AV gateway application 2.

In variants of the embodiment, the functions of the AV CONTROLLER server 7 can be implemented as software running on the computer 5, however, the embodiment of FIG. 1 is preferred for several reasons, one being that the security of the AV CONTROLLER server can be optimized if it is a dedicated hardware component.

As mentioned above, in the embodiment of FIG. 1, the customer is able to connect to the AssetVantage.com server application 1 using a browser running on any computer 6 (the term “computer” is used here to include any sort of computer, such as a PC, laptop, or mobile device such as an iPad) which is connected to the internet, to obtain an investment report. This is done using the method explained in detail below.

The embodiment is able to provide the following functions:
financial data aggregation
automated investment accounting
reporting
analytics
a marketplace for illiquid assets
automation of critical investment processes
financial and lifestyle customer defined content and news
private interest based social networking service. HNIs with specific needs, similar backgrounds and interests are able to interact with one another privately and securely.
a platform for future 3rd party applications suitable for the HNI community e.g. games, tools, utilities etc

When a customer operates one of the computers 5 on LAN 5 or the computer 6, the AssetVantage.com server application 1, the AV gateway application 2 and the AV CONTROLLER server 7 together operate to generate a user interface, e.g. as a window displayed on the computer 5 or computer 6. We now turn to a description of some of the windows which may be displayed to the customer. Suppose that the customer is named “John Smith”. If, using the user interface, the customer instructs the embodiment to display (say) his or her previous investment transactions, and then instructs the embodiment more particularly to display those investments transactions which were investments in equities, the user interface resembles the window in FIG. 2. In the largest portion of the window are a list of the customer's equity investments, with information about each. If the customer then selects the “Reliance banking fund”, the investments made in that fund are shown in more detail in FIG. 3.

If the customer now wants to get a greater overview of the portfolio, he or she clicks on the “dashboard” link at the top left of the windows of FIG. 2 or 3, and is shown a window such as that of FIG. 4. This shows the total portfolio performance, and statistical analysis of it.

The AV CONTROLLER server 7 is particularly responsible for the following activities:
Comprehensive collection of investment data and related transactions
Management of investment data
Automation of accounting entries for investments
Investment reports & analytics
Automation of critical investment processes

The AssetVantage.com server application 1 is particularly responsible for the following activities:
peer-to-peer (P2P) online classifieds & marketplace (that is, a given one of the customer is able to offer investments to the others)
Access to Merchants (i.e. those offering investment options)
Access to Service Providers
Business Networking & Community Collaboration
Contextual Content, News & Information

As mentioned above, merchants offering options for investment are able to connect to the AssetVantage.com server application 1 using their terminals 4 via the internet, to provide the embodiment with options for investment to match with the needs of the customers. It is envisaged the investment options will comprises public equities, fixed income investments, real estate, PE(private equity)/VC(venture capital)/HF(hedge fund) funds, collectibles and commodities. The merchants can upload their investment options in the form of screens which are generated based on pre-determined templates stored on the AssetVantage.com server application 1. The data input is interpreted by scripts running on the AssetVantage.com server application 1.

Service providers too are able to connect to the AssetVantage.com server application 1 (using additional terminals not shown in FIG. 1). The service providers are envisaged to include any one or more of accountants, philanthropic organisations, travel operators, research organisations, legacy archiving organisations, estate planning advisors, education organisations and family office best practices advisors. These organisations too may use one or more pre-determined templates (such as the templates for use by the merchants), but it is envisaged that certain service providers (e.g. philanthropic organisations) will not use the standard templates.

A first advantage of keeping the AssetVantage.com server application 1 and the AV gateway application 2 separate is that it provides additional security, since any communication between the AV CONTROLLER 7 and the AssetVantage.com server application 1 is via the AV gateway, where strict security can be enforced. A second advantage is that it makes it easier for the AV gateway application 2 to run other tasks asynchronously, such as user authentication or user profile updates.

Certain types of assets (e.g. shares or airline mileages) have a value which varies. Furthermore, certain types of assets (e.g. cash held in bank accounts) will be changing with time due to interest. In one possibility the AV CONTROLLER sever 7 may make contact directly over the internet using the router 3 with organisations (e.g. banks) which can provide up-to-date information. However since this may compromise the security of the system, it is preferable (subject to the licensing arrangements which may exist) if the AV gateway application 2 is in contact with the external data sources such as banks, e.g. via a data aggregation engine, to obtain up-to-date valuations. The AV CONTROLLER server 7 may issue a request to the

AV gateway application 2 for information (e.g. periodically, or when the customer instructs the AV CONTROLLER server 7 to produce a valuation), or the AV gateway application 2 may push this information to the AV CONTROLLER server 7 (e.g. periodically).

Note that the AssetVantage.com server application 1 may also be able to receive data by requesting it from external data sources, but it does not do data aggregation for the AV Controller server 7. Whereas the connection from the AV Controller server 7 to the external data sources (preferably via the AV Gateway application 2 and the data aggregation engine) is for specific financial data which impacts the customer's portfolio, the connection between the AssetVantage.com server application 1 and the external data sources is only for generic market data, such as benchmark indices (e.g. NASDAQ, FTSE etc) or currency conversion rates.

The customer may employ a “Back Office Operator” to enter certain asset class data into AV CONTROLLER server 7 if automated data aggregation from a 3rd party source is not available. This data may include data received in both manual and automated formats. AV CONTROLLER server 7 then converts this data automatically into an accounting entry in the general ledger and duly stores the same in the database of the AV CONTROLLER server 7. The entry screens are predetermined and delivered by the AV CONTROLLER server 7.

1. Risk Profiling and Tagging System

The embodiment provides its customers with a risk profiling and tagging system which:
assesses the entity's risk profile
suggests an associated model asset allocation
reports (e.g. periodically) any deviations from the stated asset allocation
maps the deviations to pertinent deals listed in a database of options for investment maintained in the AssetVantage.com server application 1, to minimize the deviation.
connects the customer to other customers and business partners in the marketplace that offer such deals, to help align the portfolio asset allocation with the stated risk profile
offers the customer more advanced insights on enhancing risk adjusted returns by leveraging third party investment analytics applications that use Efficient Market Theory as the basis for optimization.

(i) Risk Profiling

The embodiment provides a mechanism that allows the customer to complete a questionnaire to identify the risk profile of a financial entity. The questionnaire, when completed, results in a specific risk profile. The risk profile is preferably maintained in sync on both the AssetVantage.com server application 1 and the AV CONTROLLER 7. As described below, the risk profile is principally used by the AV CONTROLLER server 7. One advantage of maintaining a copy of the risk profile on the AssetVantage.com server application 1 too is that the operator of the AssetVantage.com server application 1 may wish to update the format of the risk profile from time to time (e.g. by adding a question), and this is most easily done if the risk profile is stored on the AssetVantage.com server application 1.

The AV CONTROLLER server 7, preferably in cooperation with the AssetVantage.com server application 1, then proposes different asset allocations across asset classes for that entity. For example, in one simple case, the customer may be presented with all investment options which are consistent with the risk profile.

An asset allocation will be selected and this will form the target asset allocation for that entity and will be used for reporting and monitoring purposes. This feature is critical for the customer to assess and understand the risk-and-return appetite of the entity.

(ii) Asset Allocation Calculation & Deviations

A specific outcome of the Risk Profiling feature is the Target Asset Allocation for an entity. The embodiment will calculate the Actual Asset Allocation of an entity based on the Investment Vehicle Holdings and other transactional data collected. This feature will then enable the customer to be aware of the deviations between the entity's target asset allocation and the actual asset allocation at any given time. Understanding asset allocation deviations is an imperative investment operation; this feature will thus aid the entity in decision making for future investments in order to (re)balance the investment portfolio to achieve the desired return.

(iii) Asset Allocation-Based Marketplace Listings Display

With the customer's consent, the portal will use information about a customer's asset allocation vis-à-vis their risk profile and investment interests in asset classes to determine the appropriate marketplace and business partner listings that will be displayed to the customer. For example, a customer who is underweight by 3.5 million dollars in Real Estate and operates in Mumbai may be shown investible Real Estate listings in and around Mumbai between 3 to 4 million dollars. Providing listings addressing asset class deviations and the customer's specific investment interests will help the customer optimize the portfolio and align the portfolio asset allocation with the stated risk profile.

(iv) Product & Service Risk Tagging System

Every asset class or service offered by a third party vendor (merchant) listed on the marketplace will be tagged with a specific risk profile. In the case of a merchant which only offers a single asset (e.g. a hedge fund), the risk profile may be associated with the merchant, rather than the asset. This will ensure that only the right products are showcased to the right customer.

The customer can choose to override the risk profiling and tagging system by setting his or her preferences on the system.

Service providers on the other hand incur large costs to market, sell and distribute their products/services. This is a highly relationship driven business and where such costs are not insignificant. Partnering with the operator of the AssetVantage.com server application 1 will provide service providers with the ability to cost effectively reach out to the right customers in a timely manner.

2. Report Management

Note that the arrangement of FIG. 1, the AV CONTROLLER server 7 is part of an intranet environment. Also note that it is connected to the internet through the router 3. The router 3, typically, has a dynamically assigned IP address. The embodiment makes it possible for the investor to see their financial reports by accessing the AssetVantage.com server application 1 which is in the publicly accessible internet domain using the computer 6.

Such a financial report might in principle consist of:

a) data that is obtained from database servers directly connected to the AssetVantage.com server application 1 or,

b) data obtained from remote sources using either a web service or some other means.

If the embodiment were to use the first method, the AV CONTROLLER server 7 would need to periodically push customer's wealth information to the AssetVantage.com server application 1. In such a scenario, the wealth information data of the investor would be stored on the publicly accessible AssetVantage.com server application 1. This is undesirable for investors regardless of the level of security guarantees provided by the operator of the AssetVantage.com server application 1.

The embodiment could use the second method since this allows the data to be shown in reports without being stored on the AssetVantage.com server application 1, but the natural way to implement this would be an implementation which would require the AV CONTROLLER server 7 to be directly accessible by the AssetVantage.com server application 1. This is not always possible since it requires the customers to have a publicly accessible IP address (static IP). Furthermore, once that IP address is known, there would again be security implications if the AV CONTROLLER server 7 is hacked into.

This problem is overcome by the method described below with reference to FIG. 5. This method requires the AV CONTROLLER server 7 to periodically connect with the AssetVantage.com server application 1 (via the AV gateway 2) by sending the AV gateway 2 a message (request) named a ‘heartbeat’. This connection may be made by the AV CONTROLLER server 7 periodically, e.g. with a 5 seconds periodicity.

When an investor uses computer 6 to log into the AssetVantage.com server application 1 and desires to view a report, the AssetVantage.com server application 1 generates a corresponding query and stores it locally. When AV gateway application 2 receives the next heartbeat request from the corresponding customer-side server, it informs the AV CONTROLLER server 7 that it is necessary to generate a report (i.e. that a report generation request is pending) by responding to the received request with a message including a special code. Note that the fact that the customer is logged into the AssetVantage.com server application 1 may be taken to imply that a report of some form is required. In other words, whenever a given customer is logged in to the AssetVantage.com server application 1, the message including the special code may be transmitted in response to the next heartbeat message from the corresponding AV CONTROLLER server 7.

The AV CONTROLLER server 7 initiates a new request to the AssetVantage.com server application 1 to find out which report is required to be generated. The AssetVantage.com server application 1 responds to this request and includes the specific details of the report required in the response.

The AV CONTROLLER server 7 further sends another request—this time with the complete report information as part of the request body—to the AssetVantage.com server application 1. Once AssetVantage.com server application 1 receives this information, it forwards the created report to the customer's computer 6. In this process the report information is only stored on the AssetVantage.com server application 1 in transient RAM memory associated with the web interface to the computer 6, from where the report is shown to the customer. This ensures that the customer wealth information is completely secure from unauthorized access since this information is stored in RAM and is protected from all types of unauthorized access by the operating system (e.g. Linux, although the functionality may also be implemented using Windows).

FIG. 5 is a sequence diagram which illustrates the interaction between AV CONTROLLER server 7 and AssetVantage.com server application 1. There are two aspects to this dataflow. 1. Heartbeat: The heartbeat is a process in which the AV CONTROLLER server 7 periodically (e.g. with a periodicity of 5 secs) connects with the AV gateway application 2, and thus with the AssetVantage.com server application 1. The response from AssetVantage.com server application 1 to a heartbeat request may indicate that a report generation request is pending for a particular customer (i.e. that the customer has requested a report relating to the customer-specific data stored by the AV CONTROLLER server 7). In FIG. 5, the heartbeat is shown in the form of a heartbeat request 10 sent by the AV CONTROLLER server 7 to the AV gateway application 2. In the absence of the need to generate a response, the AV gateway application 2 sends back a signal 11.

2. Report Creation Data Flow: The report-creation data flow component handles the flow of data between AssetVantage.com server application 1 and the AV CONTROLLER server 7 to ensure that the customer gets to see the reports he desires. This consists of multiple request-response sequences between AV CONTROLLER 7 and AssetVantage.com server application 1.

The following sections describe the low level architecture for AssetVantage.com server application 1 and the AV gateway application 1.

a) The AssetVantage.com Server Application 1

The AssetVantage.com server application 1 handles the scripts and components that handle the customer requests from the computer 6. When a customer operating a browser running on the computer 6 visits a specific URL to view a report (the URL may look like: http://assetvantage.com/reports/report1) the browser sends an HTTP request shown as 12 in FIG. 5 to the AssetVantage.com server application 1. As mentioned earlier, the customer's request to view the report needs to be forwarded to the corresponding AV CONTROLLER server 7. This request is also held in a waiting state until the response from the AV CONTROLLER server 7 is received. The embodiment uses the OS-provided construct of MessageQueue (MSGQ) for queuing the request information and for waiting for the generated report to be made accessible to the customer. This can be accomplished by the AssetVantage.com server application script as follows:

1. Create a msg_queue (MSGQ) for a request that is received from the browser

2. Push the report query to MSGQ. This will also include information that identifies a AV CONTROLLER server 7 uniquely.

3. Wait for response to arrive on the same MSGQ. This response is expected to arrive from the corresponding AV CONTROLLER server 7.

4. When the response comes, display the response to the customer

Note that step-3 is a blocking call. Also, note that the embodiment would create separate MSGQs for each AV CONTROLLER server 7 so that the request/response information does not get inter-mixed.

b) The AV Gateway Application 2

The AV gateway application 2 has the responsibility for managing the interface with the AV CONTROLLER server 7 to permit report generation. It contains scripts and components that handle the AV CONTROLLER interface, and it handles the request/response sequence between the AV CONTROLLER server 7 and the AssetVantage.com server application 1. It also includes the component that listens to the heartbeat requests.

For report generation, the following two sets of sequences happen:

Heartbeat

1. Receive the next heartbeat request 13 from the AV CONTROLLER server 7. This request includes the AV CONTROLLER license key.

2. Determine—by finding a MSGQ corresponding to the license key—whether a report query is pending.

3. If a report query is pending, respond to the heartbeat request with message 14 which includes a special flag 14 that indicates this status.

Report Creation

1. Receive a report finder request 15 from the AV CONTROLLER server 7 including the AV CONTROLLER license key. This requests the data specifying the type of report required.

a. Find the MSGQ corresponding to the license key

b. If the request 15 also has a response-packet included, push that response onto the MSGQ

2. If the MSGQ has further report query, pull out the report query from MSGQ 3. Send the report query 16 to the AV CONTROLLER server 7.

We now turn to a description of the AV CONTROLLER server 7. The AV CONTROLLER server 7 has a simple mechanism to handle the report creation requests. It is aware of the report query types and has scripts through which the reports are generated.

Two components of the AV CONTROLLER server 7 have a role to play in the report management function:

1. Heartbeat Component

This component periodically initiates a connection with the AV gateway application 2 and sends an HTTP request. As mentioned above, the response from AV gateway application 2 could be a response 14 which includes a special flag indicating that a report creation query is pending on AssetVantage.com server application 1. If so, the heartbeat response handler invokes the report-creator component when it identifies this special flag.

2. Report Creator Component

The report-creator component is initiated by the heartbeat response handler. It starts with sending a request 15 to the AssetVantage.com server application 1 (via the AV gateway application 2) asking for the type of report to be created. It gets this information in the response 16. It creates the required report based on information that it receives and then initiates another HTTP request 17 to the AssetVantage.com server application 1. This request 17 includes the report information as part of the content of the request, thus completing the report generation request. As already discussed, this information is then passed on to the customer through AssetVantage.com server application's MSGQ mechanism, as a transmission 18.

The exact nature of response received from AV CONTROLLER server 7 is not important—it might send data in a format such that the AssetVantage.com server application 1 can generate the report, or might send the complete report. The customer-specific data assembled by the AV CONTROLLER server 7 is never stored in any permanent storage on the AssetVantage.com server application 1 and hence no explicit “Delete” step is required. It is simply written to the MSGQ which holds the data as the in-memory (RAM) structure until the time it is read off from the AssetVantage.com side.

Note that the customer may send a message 19 to ask for additional information (e.g. detailed information) in the form of another report, and if so that AssetVantage.com server application 1 generates a message 20 to the AV CONTROLLER server 7. The AV CONTROLLER server 7 treats this in the same manner as the earlier message 16, and accordingly generates a response (not shown in FIG. 5) to the AssetVantage.com server application 1 with the additional information. This process may be repeated one or more times, until the browser of the computer 6 sends a disengage message 21. The AssetVantage.com server application 1 sends the AV CONTROLLER server 7 a response including a disengage command. The report generation process (indicated by the curved bracket in FIG. 5) is thus completed.

FIG. 5 also shows the next heartbeat request 23 and the response 24 which is generated. The response 24 is the same as the response 11, assuming that the customer's computer 6 has not issued another request for a report.

3. Options for Performing Transaction Data Save

When a web application is developed for storing investment related information, the effort for carrying out this development activity is broadly categorized into the following components:

1. Presenting a user-interface to the customer through html code. This is the html code that is developed by an application developer and this mainly consists of the input elements defined in the html spec such as “input”, “select”, etc.

2. Capturing the data entered by customer into a backend processing function. The functionality provided by the backend processing function can be segregated into two logical units:

a. Verify that the data provided by customer is correct and consistent (data-verification function)

b. Store the data into their respective tables (data-store function)

Now, there are two aspects to the data-store function based on the type of data that it has to work with:

1. data-store function for the investment data (investment-data-store function)

2. data-store function for the accounting data (accounting-data-store function)

These functions are mainly aimed at fulfilling two needs:

a. The investment data—such as the values related to purchase or sale of shares—need to be stored in a table that is generically identifiable depending on just the type of transaction (such as “purchase of equity”).

b. The accounting data—such as the values that are stored in accounting ledgers. These values need to be stored in database tables that are not only identified through the type of transaction but also have a dependency on the source of data (such as “which” broker).

A developer would typically do the following for storing investment holding information:

1. Design the database tables required for storing investment holding information.

2. Develop the screen in html using forms and html input fields.

3. Write a special validation function for the data received from the html input fields.

4. Write a special data-store function for the screen that understands the fields in a form.

In the above sequence
The validation function would be specific to the set of html input fields presented to the customer on one data entry screen.
The data-store function would be written to specifically work with the values received from the specific html input fields and the database table into which the values need to be stored is also hardcoded in the function.

1-11. (canceled)

12. A system for the preparation of a report based on customer-specific data related to investments made by a plurality of customers, the system comprising:
a portal server arranged to receive an instruction over the internet to prepare a report; and
a controller server for storing the customer-specific data, the controller server being arranged at intervals to establish a temporary communication channel with the portal server over the internet;
wherein, the controller server is arranged, upon the portal server having received an instruction to prepare a report, and the controller server having established a temporary communication channel with the portal server, to generate the report from the customer-specific data and transmit the report to the portal server through the temporary communication channel, wherein the portal server is arranged to transmit the generated report to the customer over the internet; and
wherein the controller server at intervals transmits over the internet a heartbeat message to an interface of the portal server, the heartbeat message containing data indicative of the customer and data indicative of a temporary IP address of the controller server, whereby the temporary communication channel can be established based on the temporary IP address.

13. A system according to claim 12 in which upon the portal server having received an instruction to prepare a report, and said interface having received a heartbeat message, the portal server generates a pending report message to the controller server specifying that a report is to be generated,
the controller server being arranged, upon receiving the pending report message, to send a request message to the portal server requesting details of the customer-specific data required for the report,
the portal server being arranged, upon receiving the request message, to send to the controller server a further message indicating the customer-specific data required for the report;
the controller server being arranged, upon receiving the further message, to generate the report and send to the portal server the generated report.

14. A system according to claim 12 in which the instruction received by the portal server generates an entry in a queue in a web server process, the web server process being associated with transient memory for receiving and holding said report from the controller server, the entry generating a blocking function which blocks access to the transient memory until the report is generated and transmitted to the customer.

15. A system for identifying optimised investment options for a plurality of customers, the system comprising:
an investment database configured to store investments for a plurality of asset classes;
a customer-specific database configured to store investments owned by a customer for a plurality of asset classes, and configured to update the value of the customer's investments in one or more of the plurality of asset classes;
an investment preference profile database configured to store an investment preference profile for the customer including a desired allocation between a plurality of asset classes;
a processor configured to automatically select investments for the customer, depending on the asset class of each investment, the customer's investment preference profile and the updated value of the customer's investments;
a display configured to provide the selected investments to the customer.

16. A system according to claim 15 which is configured at intervals to compare said customer-specific database with said corresponding investment preference profile database to identify any discrepancies between them, and notify the customer of any said discrepancies.

17. A system according to claim 15 which comprises a portal server and controller servers associated with the customers, said customer-specific database being stored at said controller servers.

18. A system according to claim 17 in which each controller server is arranged at intervals to establish a temporary communication channel with the portal server over the internet;
wherein, the controller server is arranged, upon the portal server having received an instruction to prepare a report, and the controller server having established a temporary communication channel with the portal server, to generate the report from the customer-specific data and transmit the report to the portal server through the temporary communication channel.

19. A system for the preparation of a report based on customer-specific data related to investments made by a plurality of customers,
the system comprising a portal server being arranged to receive:
(i) an instruction over the internet to prepare a report; and
(ii) to receive at intervals heartbeat messages from respective controller servers associated with the customers, each heartbeat message containing data indicative of the associated customer and data indicative of a temporary IP address of the controller server, whereby the temporary communication channel can be established based on the temporary IP address;
wherein, each controller server is arranged, upon the portal server having received an instruction to prepare a report in respect of the associated customer and a heartbeat message from the controller server, to generate the report from the customer-specific data and transmit the report to the portal server through the temporary communication channel, wherein the portal server is arranged to transmit the generated report to the customer over the internet.

20. A method performed by a computer system for the preparation of a report based on customer-specific data related to investments made by a plurality of customers, the system comprising:
a portal server arranged to receive an instruction over the internet to prepare a report; and
a controller server for storing said customer-specific data;
the method comprising:
the controller server at intervals establishing a temporary communication channel with the portal server over the internet by transmitting over the internet a heartbeat message to an interface of the portal server, the heartbeat message containing data indicative of a customer and data indicative of a temporary IP address of the controller server, whereby the temporary communication channel can be established based on the temporary IP address; and
upon the portal server having received an instruction to prepare a report, and the controller server subsequently establishing the temporary communication channel with the portal server, the controller server generating the report from the customer-specific data, and transmitting the report to the portal server through the temporary communication channel, the portal server transmitting the generated report to the customer over the internet.

21. A method performed by a system for identifying optimised investment options for a plurality of customers, the method comprising:
storing investments for a plurality of asset classes in an investment database;
storing investments owned by a customer for a plurality of asset classes in a customer-specific database and updating the value of the customer's investments in one or more of the plurality of asset classes;
storing an investment preference profile for the customer including a desired allocation between a plurality of asset classes in an investment preference profile database;
automatically selecting investments for the customer, depending on the asset class of each investment, the customer's investment preference profile and the updated value of the customer's investments;
providing the selected investments to the customer.

22. The system of claim 15 wherein the investment database is further configured to store accounting records for the investments.

23. The system of claim 15 wherein the customer-specific database is further configured to update the value of the customer's investments in real-time.
